(19) United States
(12) Patent Application Publication
(10) Pub. No.: US 2007/0078796 A1
(43) Pub. Date: Apr. 5, 2007

(54) Weighing feeder

(76) Inventor: Roman Kresina, Oxford, CT (US)

Correspondence Address: KENYON & KENYON LLP, 1500 K STREET N.W., SUITE 700, WASHINGTON, DC, 20005, US

(21) Appl. No.: 11/242,103

(22) Filed: Oct. 3, 2005

(51) Int. Cl. G01G 19/413

(52) U.S. Cl. 705/407

(57) ABSTRACT

A mailing machine for franking mail items. The mailing machine has a franking section having a franking head, a feeder adapted to feed mail items from a mail stack to the franking section, a dynamic scale supporting the mail stack, and a processor connected to the franking section, the feeder and the dynamic scale. The dynamic scale measures the weight of the mail stack. The processor determines a weight difference of the mail stack corresponding to the weight of a mail item fed to the franking section.

### BACKGROUND OF THE INVENTION

The exemplary embodiments described herein relate to an apparatus and method for high speed weighing and feeding.

### BRIEF DESCRIPTION OF RELATED DEVELOPMENTS

Mailing machines enable users to frank one or more mail items by printing a stamp representing the amount paid by the sender. For example, U.S. Pat. Nos. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples. Mailing systems generally comprise a separate feeder, a separate scale and then the meter where the scale and the meter are serially used one after the other in a horizontal lengthwise fashion. Here, mail is fed from the stack to the meter, weighed and subsequently fed to the franking head. A problem arises when these steps are performed serially where the time to process a piece of mail is extended. A further problem arises when the individual apparatus'for the feeder, scale and meter are placed in line, increasing the length of and the required space for the mailing machine. Accordingly, it would be advantageous to create a system that is capable of metering at speeds faster than presently available systems where the system uses less space than presently available systems.

### SUMMARY OF THE EXEMPLARY EMBODIMENTS

In accordance with one exemplary embodiment, a mailing machine is provided for franking mail items. The mailing machine has a franking section having a franking head and a feeder adapted to feed mail items from a mail stack to the franking section. A dynamic scale is provided supporting the mail stack. A processor is provided connected to the franking section, the feeder and the dynamic scale. The dynamic scale measures the weight of the mail stack. The processor determines a weight difference of the mail stack corresponding to the weight of a mail item fed to the franking section.

In accordance with another exemplary embodiment, a weighing feeder is provided for weighing and feeding stacked media. The weighing feeder has a feeder adapted to feed the media from a media stack to a location adjacent the media stack. A dynamic scale is provided supporting the media stack. A processor is provided connected to the dynamic scale and the feeder. The dynamic scale measures the dynamic load applied to the dynamic scale by the media stack. The processor filters samples taken from the dynamic scale and determines a difference corresponding to the weight of a media item fed to the location adjacent the media stack.

In accordance with another exemplary embodiment, a method of weighing and feeding stacked media comprising is provided having a step of taking a first weight measurement of a stack of media. A step of feeding a media item from the stack is the provided. A step of taking a second weight measurement of the stack of media is then provided. A step of determining the weight of the media item by subtracting the second weight measurement from the first weight measurement is then provided.

### BRIEF DESCRIPTION OF THE DRAWINGS

The foregoing aspects and other features of the present invention are explained in the following description, taken in connection with the accompanying drawings, wherein:

FIG. 1 shows a block diagram of an exemplary embodiment incorporating features of the present invention; and

FIG. 2 shows a flow diagram of a method according to an exemplary embodiment.

### DETAILED DESCRIPTION OF THE EXEMPLARY EMBODIMENTS

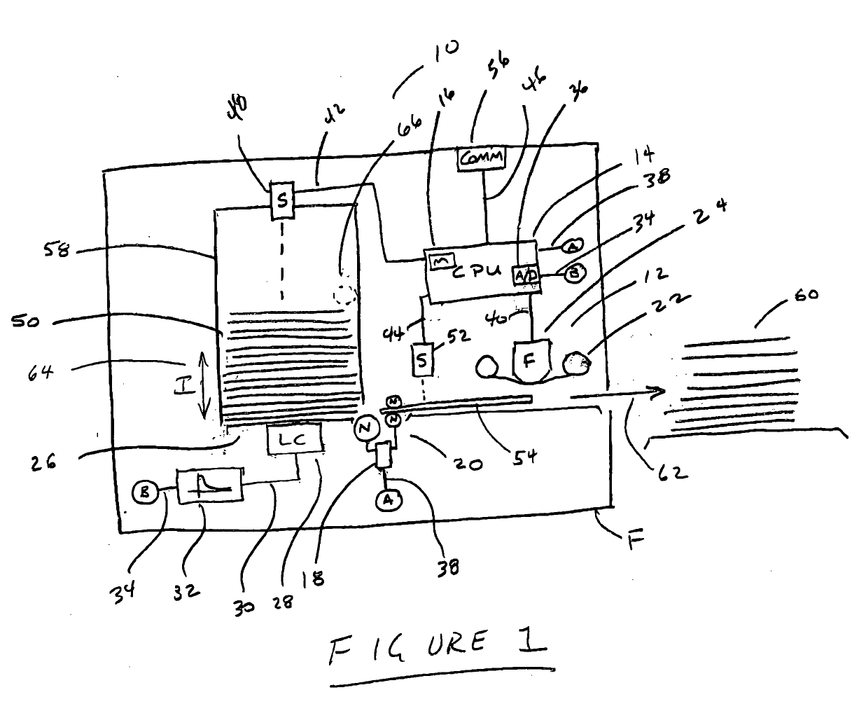

Referring to FIG. 1, there is shown, a schematic block diagram of a mailing machine 10 incorporating features in accordance with one exemplary embodiment of the present invention. Although the present invention will be described with reference to the embodiments shown in the drawings, it should be understood that the present invention can be embodied in many alternate forms of embodiments. In addition, any suitable size, shape or type of elements or materials could be used.

In the exemplary embodiment shown, mailing machine 10 and its sections described in greater detail below is merely exemplary, and in alternate embodiments the mailing machine may have any other sections or systems. For example, in alternate embodiments, mailing machine 10 may comprise a printer, copier or other suitable media processing device. Mailing machine 10 accepts individual or stacked mail items 50 in input buffer section 58 and processes individual pieces of mail 54 along media path 62 to output buffer section 60. Mailing machine 10 generally has a franking device 12 and processor 14 which effects operation of the franking machine. In alternate embodiments, processor 14 may comprise multiple processors, for example, where the multiple processors are distributed throughout the mailing machine. Memory 16 may be provided to store data. Motor controller(s) 18 may be provided for driving items such as insertion device or feeder 20 or marking means such as ink ribbon 22, or impression roller and raise/lower drive 24. Here feeder 20 interfaces with processor 14 over interface 38 and printing apparatus 24 over interface 40. In alternate embodiments, the mailing machine may have any other suitable marking means 24 such as an ink jet head or laser printing head. Dynamic Scale 26 may be provided, for example having load cell 28 where load cell 28 provides an output 30 corresponding to the load applied, for example, to scale 26 or cell 28. As will be described below in greater detail, filter 32 may be provided to filter and/or signal condition output 30 prior to passing signal 34 to analog to digital converter 36 where processor 14 may access the data corresponding to the load applied. In alternate embodiments, output 30 may be any suitable interface, for example, a digital or other interface direct to processor 14. Multiple inputs and outputs may be provided, for example 42, 44, 46 to interface processor 14 to sensors or other devices, such as optical detectors, indicators, actuators or otherwise. For example, interface 42 may be provided to interface height sensor 48 to processor 14 where height sensor 48 senses the height of a stack of media 50, such as mail. As a further example, interface 44 may be provided to interface thickness sensor 52 to processor 14 where thickness sensor 52 senses the thickness of an individual piece of media 54, such as a piece of mail 54 being fed by feeder 20 to print head 24. In alternate embodiments. As a further example, interface 46 may be provided to interface communication interface 56 to processor 14 where communication interface 56 interfaces machine 10 to any suitable peripheral. In alternate embodiments, additional peripheral devices such as display, keyboard, print element, modem, folder, insertion device, moistener/sealer, label dispenser, ink cartridge, speaker device, or any other suitable peripheral devices may be provided. FIG. 1 shows that one or more of the sections of the mailing machine 10 may be mounted or held on a frame F. The frame F is shown schematically in FIG. 1, and may comprise a number of frame portions that may be connected or independent of each other. As noted before, the machine 10 shown in FIG. 1 and described above is merely exemplary and not meant to be the exclusive embodiment. Throughput may be controlled by processor 14. For example, the buffer 50, the printing media inserter 20, and the print head 24 may be controlled from processor and memory 14, 16 for optimum printing media throughput. The speed of the inserter, buffer, and media path may be controlled in conjunction with the information sent to each print head in order to achieve optimum throughput. The media path may travel at a variable speed or at a constant speed. The inserter, buffer, media path, and print head may communicate with each other over a communication path and may be operated by a controller or processor 30 under the control of one or more programs. In alternate embodiments, more or less features may be provided, such as where more, less or different components are provided. Further, for example, a wireless or computer interface could be provided, or a battery may be disposed within mailing machine 10. As yet a further example, a custom message interface could be provided or docking interfaces, power interface, status indicators, other connections, labels, network connections, additional user interfaces, or otherwise may be provided.

In the embodiment of Fig. 1, mailing machine 10 has a feeder 20 and weighing section 26. Here, weighing section 26 dynamically tracks the load being applied, for example, by the weight of stack 50 or by the weight of feeder 20. In alternate embodiments, more or less sections or items may apply loads to section 26. Here the load applied to section 26 dynamically varies, such as where a piece of mail 54 is removed by feeder 20 from stack 50. Here, for example, the load may vary from factors such as the removal of the weight of mail piece 54 from stack 50, vibration loads being applied by feeder 20, dynamic loads being applied by feeder 20, other dynamic loads, such as where printing head 24 is activated. Here, the weighing portion is affected by loads applied by the stack as well other dynamic effects of the apparatus where the raw output 30 appears as a dynamic weight. Unlike systems where there is a separate feeder, a separate dynamic scale and a meter adding in horizontal length, in the present embodiment, feeder 20 may be integrated with weighing component 26 where the one device may essentially accommodate a stack of mail 50. Here, and as each piece comes off of the stack, the difference in the weight may be calculated, for example, for metering purposes. With the dynamic output 30 of weighing section 26, vibration, for example, due to the mechanics of the feeder, may not allow the accurate reading of the weight by conventional techniques. To account for this effect, as will be described in greater detail below, weight measurements and/or data may be filtered, for example, by taking a running average in the analog domain of load cell 28 before feeding the signal to analog to digital converter 36 where processor 14 may conduct multiple samples on analog to digital converter 36 output to determine, for example, an average weight where a stable weight may be determined in the presence of noise, such as vibration induced noise. Here, the weight measurements may be conditioned and/or filtered to essentially remove and/or cancel out the vibration through appropriate filtering and sampling. In this manner, for example, the feeder mechanics may be similar to a conventional feeder feeding media directly into the mailing machine.

In the embodiment shown in FIG. 1, mailing machine 10 for franking mail items 50 has franking section 12 having franking head 24 and feeder 20 adapted to feed mail items 54 from mail stack 50 to franking section 12. Dynamic scale 26 has load cell 28 and supports mail stack 50. In alternate embodiments, scale 26 may support other components, such as feeder 20. Processor 14 may be connected to franking section 12, feeder 20 and dynamic scale 26. In alternate embodiments, processor 14 may be connected to other components. In alternate embodiments, processor 14 may comprise additional processors. In operation, dynamic scale 26 measures the weight of mail stack 50. Here, dynamic scale 26 may continuously monitor the load applied by stack 50 including some offset for other load applied. Here, dynamic scale 50 may continuously monitor the load applied, for example, to load cell 28. In alternate embodiments, dynamic scale may take discrete measurements of the load applied where, for example, processor 14 issues a command to scale 26 to take such a measurement. Processor 14 determines a weight difference of mail stack 50 corresponding to the weight of mail item 54 fed to franking section 12 by taking one or more measurements of the load applied to load cell 28 before and after item 54 is removed. In the embodiment shown, dynamic scale 26 supports feeder 20; however in alternate embodiments, feeder 20 may be independently supported or may not apply a load to cell 30, for example where feeder 20 may engage and disengage stack 50. In the embodiment shown, feeder 20 feeds material from the bottom of stack 50; however, in alternate embodiments, feeder 20 may feed material from the top of stack 50, such as where feeder 20 is applied, for example at location 66 relative to stack 50, where indexer 64 engages the stack with feeder 66 to feed material to head 24. Processor 14 may take more than one sample of the weight of mail stack 50 before mail item 54 is fed. Processor 14 may take more than one sample of the weight of mail stack 50 after mail item 54 is fed. Processor 14 may apply any suitable algorithm to determine an accurate load being applied to cell 28 where such algorithm filters dynamic loads being applied to cell 28. Such filters may comprise digital filters, for example, low pass filters or otherwise, applied to data sampled by processor 14. For example, processor 14 may average the samples to determine the weight difference where processor 14 may take samples of the weight of mail stack 50 before and after mail item 54 is fed. In this manner, processor 14 may filter the samples to determine the weight difference. Processor 14 is connected to load cell 28 via interconnect 30. In the embodiment shown, interconnect 30 may provide an analog signal corresponding to the load being applied. In alternate embodiments, interconnect 30 may provide digital signals corresponding to the load being applied. Here, output 30 of dynamic scale 26 may comprise an analog signal, where processor 14 is connected to the analog signal of the dynamic scale via analog to digital converter 36. Here, processor 14 samples the output of analog to digital converter 36 to determine the difference corresponding to the weight of media item 54 fed to the location adjacent media stack 50. Analog signal 30 may be filtered by analog filter 32. Processor 14 may be connected to dynamic scale 26 via filter 32 where processor 14 may sample the weight of mail stack 50 before and after mail item 54 is fed to determine the weight difference. Filter 32 may comprise signal conditioning circuitry or a filter, such as a low pass gilter or otherwise. Here, dynamic scale 26 may output an analog signal 30 to filter 32 where processor 14 is connected to dynamic scale 26 via the filter 32, where processor 14 may take multiple samples of the weight of mail stack 50 before and after mail item 54 is fed to determine the weight difference. In alternate embodiments, processor 14 may take individual measurements before and after feeding where processor 14 relies on filter 32 to remove dynamic effects. Stack height detector 48 may be connected to processor 14, where stack height detector 48 is adapted to detect a height of mail stack 50. Here, processor 14 may determine a stack height difference of mail stack 50 corresponding to the thickness of mail item 54 fed to franking section 12. Mail thickness detector 52 may be connected to processor 14, where mail thickness detector 48 is adapted to detect a thickness of mail item 54. Here, processor 14 compares the thickness of mail item 54 to the stack height difference to determine, for example, if additional material has been added or removed from stack 50 allowing processor 14 to compensate. Scale 26 and feeder 20 may be located below mail stack 50. In alternate embodiments, feeder 20 may be located above the mail stack, for example, in location 66 where indexer 64 may be provided. Here, a weighing feeder for weighing and feeding stacked media 50 is provided where the weighing feeder has a feeder 20 adapted to feed media from media stack 50 to a location adjacent the media stack, for example, section 12 with dynamic scale 26 supporting media stack 50. As described, dynamic scale 26 measures the dynamic load applied to dynamic scale 26 by media stack 50, where processor 14 filters samples taken from dynamic scale 26 and determines a difference corresponding to the weight of media item 54 fed to the location adjacent media stack 50. Media 50 may comprises mail, and the location adjacent the media stack may comprise franking section 12 having franking head 24. Processor 14 may filter the samples, for example, by averaging the samples. In alternate embodiments, feeder 20 may feed media items from the top of stack 50. In alternate embodiments, feeder 20 may feed media item 54 from the bottom of stack 50.

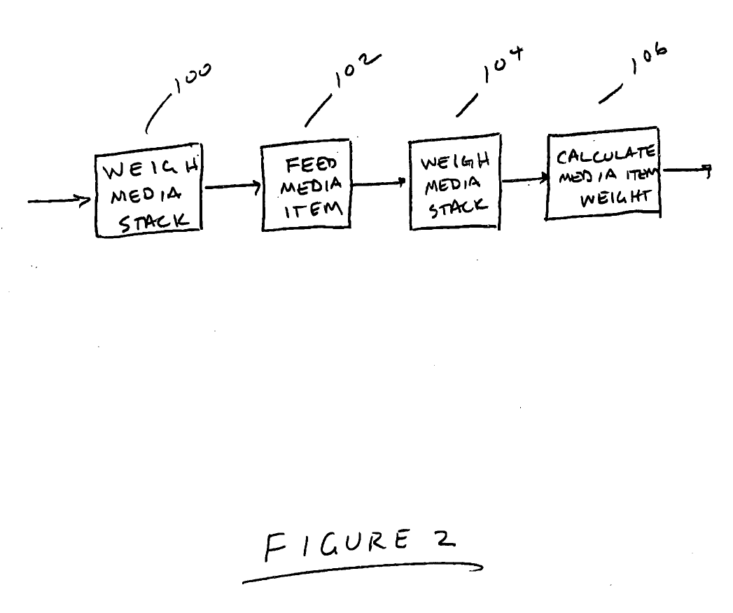

Referring also to FIG. 2, a method of weighing and feeding stacked media having a first step 100 of taking a first weight measurement of a stack of media. A step 102 of feeding a media item from the stack is then provided. A step 104 of taking a second weight measurement of the stack of media is then provided; and a step 106 of determining the weight of the media item by subtracting the second weight measurement from the first weight measurement is the provided. The step 100 of taking a first weight measurement of a stack of media may comprise steps of sampling and averaging weight measurements of the stack of media. The step 104 of taking a second weight measurement of a stack of media may comprise sampling and averaging weight measurements of the stack of media. Further steps of detecting the height of the stack of media and detecting the thickness of the media item may be provided.

It should be understood that the foregoing description is only illustrative of the invention. Various alternatives and modifications can be devised by those skilled in the art without departing from the invention. One such example is where other configurations of printheads may also be used. Accordingly, the present invention is intended to embrace all such alternatives, modifications and variances which fall within the scope of the appended claims.

What is claimed is:

1. A mailing machine for franking mail items comprising:
a franking section having a franking head;
a feeder adapted to feed mail items from a mail stack to the franking section;
a dynamic scale supporting the mail stack; and
a processor connected to the franking section, the feeder and the dynamic scale;
wherein, the dynamic scale measures the weight of the mail stack, and wherein the processor determines a weight difference of the mail stack corresponding to the weight of a mail item fed to the franking section.

2. The mailing machine of claim 1, wherein the dynamic scale supports the feeder.

3. The mailing machine of claim 1, wherein the processor takes more than one sample of the weight of the mail stack before the mail item is fed, and wherein the processor takes more than one sample of the weight of the mail stack after the mail item is fed, and wherein the processor averages the samples to determine the weight difference.

4. The mailing machine of claim 1, wherein the processor takes samples of the weight of the mail stack before and after the mail item is fed, and wherein the processor filters the samples to determine the weight difference.

5. The mailing machine of claim 1, wherein the processor is connected to the dynamic scale via a filter, and wherein the processor samples the weight of the mail stack before and after the mail item is fed to determine the weight difference.

6. The mailing machine of claim 1, wherein the dynamic scale outputs an analog signal to a filter, and wherein the processor is connected to the dynamic scale via the filter, and wherein the processor takes multiple samples of the weight of the mail stack before and after the mail item is fed to determine the weight difference.

7. The mailing machine of claim 1 further comprising a stack height detector connected to the processor, the stack height detector adapted to detect a height of the mail stack, wherein the processor determines a stack height difference of the mail stack corresponding the thickness of the mail item fed to the franking section.

8. The mailing machine of claim 7 further comprising a mail thickness detector connected to the processor, the mail thickness detector adapted to detect a thickness of the mail item, wherein the processor compares the thickness of the mail item to the stack height difference.

9. The mailing machine of claim 1, wherein the scale is located below the mail stack.

10. A weighing feeder for weighing and feeding stacked media, the weighing feeder comprising:
a feeder adapted to feed the media from a media stack to a location adjacent the media stack;
a dynamic scale supporting the media stack; and
a processor connected to the dynamic scale and the feeder;
wherein, the dynamic scale measures the dynamic load applied to the dynamic scale by the media stack, and wherein the processor filters samples taken from the dynamic scale and determines a difference corresponding to the weight of a media item fed to the location adjacent the media stack.

11. The weighing feeder of claim 10, wherein the output of the dynamic scale comprises an analog signal, and wherein the processor is connected to the analog signal of the dynamic scale via an analog to digital converter, and wherein the processor samples the output of the analog to digital converter to determine the difference corresponding to the weight of a media item fed to the location adjacent the media stack.

12. The weighing feeder of claim 11, wherein the analog signal is filtered by an analog filter.

13. The weighing feeder of claim 10, wherein the media comprises mail, and wherein the location adjacent the media stack comprises a franking section having a franking head.

14. The weighing feeder of claim 10, wherein the processor filters the samples by averaging the samples.

15. The weighing feeder of claim 10, wherein the feeder feeds the media item from the top of the stack.

16. The weighing feeder of claim 10, wherein the feeder feeds the media item from the bottom of the stack.

17. A method of weighing and feeding stacked media comprising the steps of:
taking a first weight measurement of a stack of media;
feeding a media item from the stack;
taking a second weight measurement of the stack of media; and
determining the weight of the media item by subtracting the second weight measurement from the first weight measurement.

18. The method of claim 17, wherein the step of taking a first weight measurement of a stack of media comprises sampling and averaging weight measurements of the stack of media, and wherein the step of taking a second weight measurement of a stack of media comprises sampling and averaging weight measurements of the stack of media.

19. The method of claim 17, further comprising the step of detecting the height of the stack of media.

20. The method of claim 19, further comprising the step of detecting the thickness of the media item.
